(19) United States
(12) Patent Application Publication
(10) Pub. No.: US 2014/0143075 A1
(43) Pub. Date: May 22, 2014

(54) SYSTEM AND METHOD FOR POINT-OF-SALE TRANSACTIONS

(71) Applicant: E3 Retail LLC, Raleigh, NC (US)

(72) Inventors: Douglas Wilson Eason, JR., Raleigh, NC (US); Barry T. Henderson, Rancho Santa Fe, CA (US); Kenneth L. Jenkins, Raleigh, NC (US); Swetank Shekhar, Raleigh, NC (US)

(73) Assignee: E3 Retail LLC, Raleigh, NC (US)

(21) Appl. No.: 14/056,744

(22) Filed: Oct. 17, 2013

Related U.S. Application Data
(60) Provisional application No. 61/715,579, filed on Oct. 18, 2012.

(51) Int. Cl. G06Q 20/20

(52) U.S. Cl. CPC G06Q 20/204
USPC 705/17; 235/380

(57) ABSTRACT

Point-of-sale transaction processing is disclosed. In one innovative aspect, there is a point-of-sale system. The point-of-sale system includes a device manager configured to receive a token as input. The token may be associated with a mobile device. The token may also be associated with a particular provider (e.g., store, bank, loyalty program). The system includes a payment information engine configured to map the token to payment information such as a credit card track based at least in part on the received token. In the system, the device manager is further configured to transmit the payment information to a point-of-sale application.

### CROSS REFERENCE TO RELATED APPLICATIONS

This application claims a priority benefit under 35 U.S.C. §119(e) from U.S. Provisional Patent Application No. 61/715,579, entitled “SYSTEM AND METHOD FOR POINT-OF-SALE TRANSACTIONS,” filed Oct. 18, 2012, which is incorporated by reference in their entirety. Any and all priority claims identified in the Application Data Sheet, or any correction thereto, are hereby incorporated by reference under 37 C.F.R. §1.57.

### BACKGROUND

1. Field

The present invention relates to point-of-sale systems, and, more particularly, to a system and method for implementing electronic payments in existing point-of-sale systems.

2. Description of Related Technology

Point-of-sale systems may be provided to consummate a transaction between a buyer and a seller. For example, grocery stores include self-scan systems which allow customers use various point-of-sale peripheral devices to scan products, indicate a loyalty program, receive visual feedback, provide payment information, capture a signature, print receipts, and other activities related to the transaction. Other point-of-sale systems may include a check-out attendant who performs some of the functions for the buyer on behalf of the seller. Such systems may be deployed in a variety of setting such as grocery stores, consumer stores, fitness centers, restaurants, and the like.

Changing existing point-of-sale systems often entails taking a system offline such that it cannot be used while upgrading. This may limit the seller's ability to process customer's needs in a timely fashion. Furthermore, the changes may require additional investment or reconfiguration of the existing system to provide updated point-of-sale peripherals.

### SUMMARY OF CERTAIN INNOVATIVE ASPECTS

The systems, methods and devices of the disclosure each have several innovative aspects, no single one of which is solely responsible for the desirable attributes disclosed herein.

In one innovative aspect, a point-of-sale system is provided. The point-of-sale system includes a device manager configured to receive a token as input. The token may be associated with a mobile device. The token may also be associated with a particular provider (e.g., store, bank, loyalty program). The system includes a payment information engine configured to map the token to payment information such as a credit card track based at least in part on the received token. In the system, the device manager is further configured to transmit the payment information to a point-of-sale application.

In some implementations, the device manager is in data communication with a receipt transmitter and the device manager is configured to receive transaction information from the point-of-sale application; and provide the transaction information to a network for electronic transmission. The device manager may be configured to receive a QR code indicating the token information. In some implementations, the token may be received via near field communication.

In another innovative aspect, a mobile payment device is provided. The device includes a storage unit storing an identifier for the device. The device also includes a registration circuit configured to transmit a message including payment information and the identifier for the device. The device further includes a token processor configured to obtain a token based at least in part on the identifier for the device. The device also includes a token transmitter configured to transmit the obtained token as a form of payment for a transaction.

In yet another innovative aspect, a mobile payment device for generating and validating payment tokens is provided. The device includes a registration circuit configured to receive a message including payment information and an identifier for a mobile device. The device includes a token generator configured to generate a token based on the received payment information and mobile device identifier. The device further includes a token transmitter configured to transmit the token to the mobile device.

### BRIEF DESCRIPTION OF THE DRAWINGS

The above mentioned and other features of this disclosure will now be described with reference to the drawings of several implementations of the present point-of-sale systems and methods. The illustrated implementations of the systems and methods are intended to illustrate, but not to limit the disclosure. The drawings contain the following figures:

FIG. 1 shows a functional block diagram of a point-of-sale system.

FIG. 2 shows a process flow diagram for a method of transmitting a request to a point-of-sale peripheral device.

FIG. 3 shows a process flow diagram for a method of receiving information from a point-of-sale peripheral device.

### DETAILED DESCRIPTION OF CERTAIN ILLUSTRATIVE EMBODIMENTS

Retail applications may include methods to access point-of-sale peripherals such as magnetic stripe reader, scanner, point-of-sale (POS) printer. In a Windows environment, access to these peripherals generally occurs through UPOS (OPOS) based driver. In an IBM environment, access to these point-of-sale peripherals is generally achieved through pre-defined software interrupt and/or application programming interfaces. System configurations leveraging such middleware to provide token based payment and digital receipts are described below.

In one aspect, insertion of certain components between lower level driver and the application allows interception / management of data to and from these point-of-sale peripherals. Using this middleware, mobile payment and digital receipt capabilities can be implemented using existing peripherals, without requiring any changes to the retail POS application.

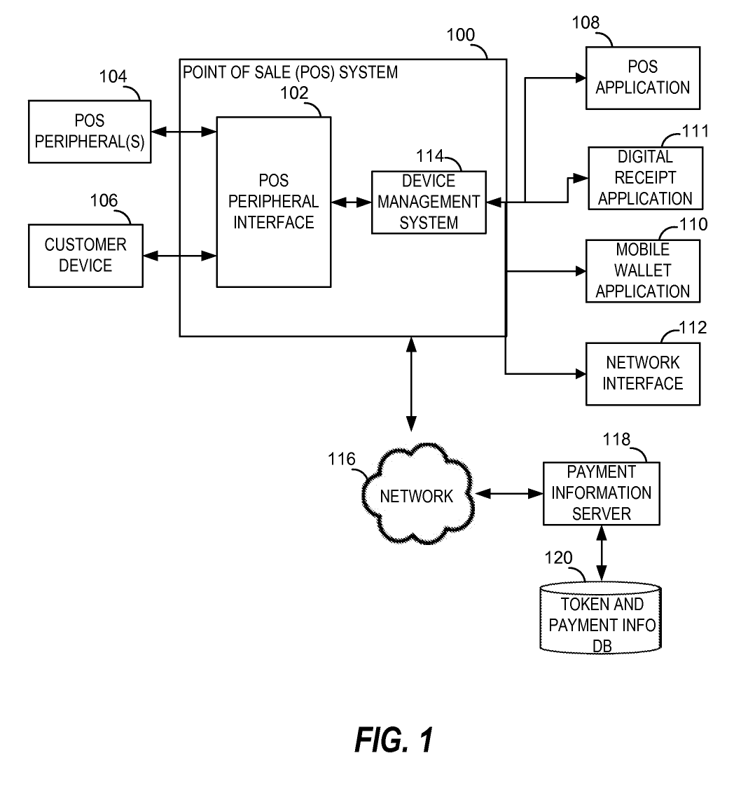

FIG. 1 shows a functional block diagram of a point-of-sale system. The point-of-sale system 100 shown includes a point-of-sale peripheral interface 102. The point-of-sale peripheral interface 102 is configured to exchange messages/signals between one or more point-of-sale peripheral devices 104. Examples of point-of-sale peripheral devices include magnetic strip reader, scanner, printer, display, and the like. The point-of-sale peripherals 102 may provide input data associated with a point-of-sale transaction.

The point-of-sale system 100 includes a point-of-sale application 108 that coordinates the point-of-sale transaction. In conventional POS systems, the point-of-sale application 108 is in data communication the point-of-sale peripheral interface 102 to send and receive transaction information.

A customer device 106 may be configured to communicate with the point-of-sale system 100. One way the customer device 106 may communicate with the point-of-sale system is via a mobile wallet application 110. The mobile wallet application 110 may be configured to send and receive mobile payment information from the customer device 106. For example, the customer device 106 is configured to provide a mobile payment token to the mobile wallet application 110 via near field communication (NFC), transmitting a numeric token, providing a scannable image (e.g., barcode or QR code) including the token information, and the like. In some implementations, the token may be received on an existing point-of-sale peripheral 104 such as a keypad or near field communication (NFC) device. The mobile wallet application 110 may be configured to obtain payment information, such as credit card data, based at least in part on the received mobile payment token.

As shown in FIG. 1, a network interface 112 is typically included in the point-of-sale system 100. The network interface 112 provides a communication channel to a network 116 which is also coupled with a payment information server 118. The mobile wallet application 110 provides a received token via the network interface 112 to a payment information server 118. The payment information server 118 has a database 120 storing the token information and payment information. The payment information includes credit card information associated with the token. In this way, the token enables secure provisioning of the payment information.

A device management system 114 is the middleware that intercepts the token information during the transaction. For example, the device management system 114 receives a request message/signal from the point-of-sale application 108 for payment information. The device management system 114 may, in lieu of triggering a credit card reader to receive credit card data, obtain and retrieve payment information via the mobile wallet application. The payment information may then be provided to the point-of-sale application 108 as if a credit card was swiped using a point-of-sale peripheral 104. One implementation of a device management system 114 is described in further detail in, for example, pages 1-17 the attached Appendix A which is incorporated in its entirety.

The device management system 114 may also be configured to interface with other point-of-sale peripherals. For example, upon completion of a transaction, receipt information may be transmitted to a printer. The device management system 114 may intercept this information and provide the receipt information via a different channel. For example, the device management system 114 may transmit the receipt information via email or a web interface to the customer. A digital receipt application 111 may receive the receipt information and determine the proper routing of the receipt. The digital receipt application 111 may be in data communication with a customer preference database which includes receipt delivery information for the customer. Based on these preferences, the digital receipt application 111 may email the receipt, transmit a text message to the customer's mobile device, and/or otherwise provide the receipt information to the channels selected by the customer's preferences. In some implementations, the digital receipt application 111 may be configured to re-organize the receipt information based on the channel selected for delivery. For instance, a text message may include the total and time of transaction while an email may include details about each item. In some implementations, the receipt delivery mechanism may be specified for each user, such as via information obtained via the mobile wallet application 110. Further details of the digital receipt application 111 may be found, for example, on page 44 of the attached Appendix A.

Other information that may be included in the mobile wallet information may be customer loyalty information. For example, the token may also provide information to identify the customer's frequent shopper account. The point-of-sale system 100 may be configured to provide the loyalty information to the point-of-sale application 108.

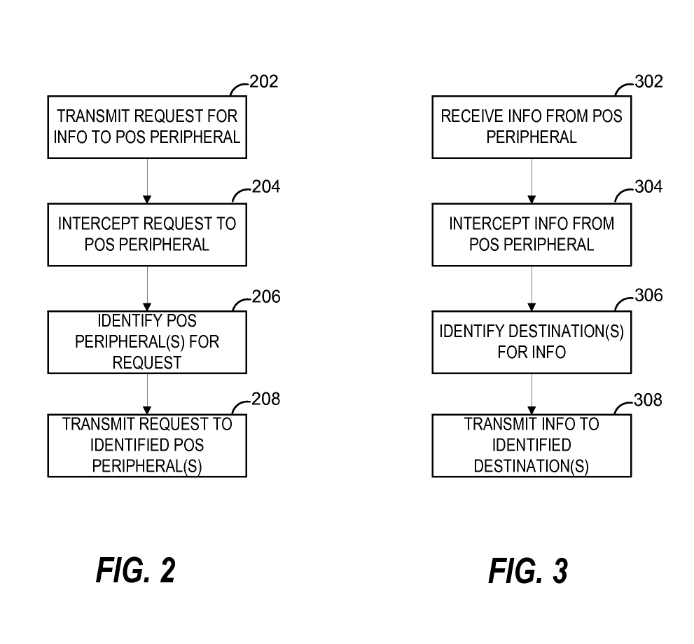

FIG. 2 shows a process flow diagram for a method of transmitting a request to a point-of-sale peripheral device. The process flow may be implemented in whole or in part by one or more of the components shown in FIG. 1. At block 202 a request is transmitted to a point-of-sale peripheral. For example, the point-of-sale application 108 may transmit a request for an item scan to a scanner. The request may be sent to the device management system 114.

At block 204, the device management system 114 intercepts the request to the point-of-sale peripheral. The point-of-sale application 108 may not be aware that the device management system 114 has received the request. In the example above, from the perspective of the point-of-sale application 108, the request is transmitted to the scanner.

At block 206, the device management system 114 identifies one or more point-of-sale peripherals to service the request. In the example of the scanner, the device management system 114 may be configured to select a scanner for all scanning requests. For example, the scanner may be an optical scanner attached to the point-of-sale system 100. In some implementations, the scanner may be a tablet computer including a camera. In this way, scanning request from the existing point-of-sale application 108 may be routed to new/different point-of-sale peripherals without the need to update the point-of-sale application 108.

At block 208, the request is transmitted to the identified point-of sale peripheral. In some implementations, the information may be transmitted to an application. For example, if a request to print a receipt is transmitted from the point-of-sale application 108 to a printer, the device management system 114 may intercept this request. The request may be forwarded the request to the digital receipt application 111 for further processing as described above.

As shown in FIG. 1, the customer device 106 may also be in data communication with the point-of-sale system 100. As such, the customer device 106 may register with the point-of-sale system 100 and be used as a point-of-sale peripheral. For example, a smartphone may register with a point-of-sale system 100 upon entering a store using a local area network provided by the store. During check-out, if the point-of-sale application 108 transmits a request to a credit card reader for payment information, the device management system 114 may intercept this request and route the payment information request to the customer device 106. The customer device 106 is then used to provide payment information, such as an e-wallet token, as a form of payment for the transaction. Receiving information from a point-of-sale peripheral will be described in further detail below.

FIG. 3 shows a process flow diagram for a method of receiving information from a point-of-sale peripheral device. The process flow may be implemented in whole or in part by one or more of the components shown in FIG. 1. At block 302, information is received from the point-of-sale peripheral. The information is transmitted via a point-of-sale peripheral interface 102 to the device management system 114. The information may include transaction information such as a scanned barcode, biometrics, credit card data, debit card data, PIN pad entry, signature data, touch screen response, and the like.

At block 304, the device management system 114 may intercept the information transmitted from the point-of-sale peripheral. From the perspective of the point-of-sale peripheral, the information has been transmitted to the point-of-sale system 100. However, The device management system 114 may be configured to route the received information to one or more other destinations.

At block 306, the device management system 114 identifies one or more destinations for the received information. The identification may be based on the received information, the point-of-sale peripheral providing the information, the specified destination for the information, or other aspect of the transaction (e.g., amount, items, and customer loyalty status).

At block 308, the information is transmitted to the identified destination(s). In one case, such as a credit card swipe, the information may be sent to the point-of-sale application 108. In one case, the information may include a payment token. The device management system 114 may be configured to transmit this token information to a payment information server 118 to obtain payment information such as an authorization for the amount of the transaction.

Further details regarding the transmitting of a request from the point-of-sale application and receipt of information for a mobile wallet application may be found, for example, in pages 18-28 of the attached Appendix A.

One non-limiting advantage of the proposed system and methods includes a streamlined implementation of digital receipt using existing point-of-sale peripherals. For example, by using the point-of-sale system 100, receipt print data may be automatically routed/forwarded to centralized location hosted either by retailer or with retailer/consumer approval in cloud infrastructure.

A further non-limiting advantage of the proposed system and methods includes a streamlined implementation for digital payments such as e-wallets. DMS allows token/passcode data to be entered using any of the peripheral devices including keyboard and then reaches out to centralized server to resolve to either a credit card token OR actual credit card (depending on retailers preference) and automatically feed to POS application as if the card data was swiped on the POS peripheral. Thus the system secures/protects consumer and retailer from the credit card fraud as credit card data is protected and is never presented in clear.

Another non-limiting advantage of the proposed systems and methods includes a reduced point-of-sale peripheral footprint. As described in FIG. 1, DMS may be configured for remote binding of point-of-sale peripheral devices. Thus a tablet, workstation, or any other networked device can remotely attach (bind) as a POS peripheral attached to a POS register/tender station. Thus retailers can reduce POS peripheral foot print in their store by sharing these peripheral devices across multiple clients.

A further non-limiting advantage of the proposed systems and methods includes a streamlined selling process. Many retailers would like to facilitate selling experience by taking their selling application on a mobile device like tablet, smart phone on sales floor with the customer, complete interaction with customer (selling process) on sales floor and then complete the sales transaction by remotely binding to POS peripheral like sigpad device/cash drawer.

Yet another non-limiting advantage of the described systems and methods is the seller may utilize token in lieu of credit card information to complete a transaction. This reduces the number of transmissions of sensitive information such as credit card data through the seller's point-of-sale system. This also allows a seller better control over the forms of payment received because each seller may implement their own token program. In this way, each seller may provide a custom payment mechanism with the desired level of security. For example, one time tokens which are active for certain periods of time may be provided by the sellers. Tokens which limit the amount of purchasing, or types of purchases may also be provided. Further description of the tokenization process, how a customer obtains a token, how a merchant provides tokens, and how tokens may be used may be found on pages 29-43 of the attached Appendix A.

Additional examples of non-limiting advantages of the processes described herein may be found on page 45 of the attached Appendix A.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an application specific integrated circuit (ASIC).

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, the terms “determine” or “determining” encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

What is claimed is:

1. A point-of-sale system comprising:
a device manager configured to receive a token as input; and
a payment information engine configured to map the token to payment information based at least in part on the received token,
the device manager being further configured to transmit the payment information to a point-of-sale application.

2. The system of claim 1, wherein the token is associated with at least one of a mobile device and a service provider.

3. The system of claim 2, wherein the service provider includes one of a store, a bank, or a loyalty program.

4. The system of claim 1, wherein the payment information comprises a credit card track.

5. The system of claim 1, wherein the device manager is in data communication with a receipt transmitter, and wherein the device manager is configured to:
receive transaction information from the point-of-sale application; and
provide the transaction information to a network for electronic transmission.

6. The system of claim 1, wherein the device manager is configured to receive a QR code indicating the token information.

7. The system of claim 1, wherein the token is received via near field communication.

8. A mobile payment device comprising:
a storage unit storing an identifier for the device;
a registration circuit configured to transmit a message including payment information and the identifier for the device;
a token processor configured to obtain a token based at least in part on the identifier for the device; and
a token transmitter configured to transmit the obtained token as a form of payment for a transaction.

9. The device of claim 8, wherein the token is associated with at least one of a mobile device and a service provider.

10. The device of claim 9, wherein the service provider includes one of a store, a bank, or a loyalty program.

11. The device of claim 8, wherein the payment information comprises a credit card track.

12. The device of claim 8, wherein the token obtained by the token processor comprises a QR code.

13. A mobile payment device for generating and validating payment tokens comprising:
a registration circuit configured to receive a message including payment information and an identifier for a mobile device;
a token generator configured to generate a token based at least in part on the payment information and the identifier; and
a token transmitter configured to transmit the token to the mobile device.

14. The device of claim 13, wherein the message includes a service provider identifier, and wherein the token generator is further configured to generate the token based on the service provider identifier.

15. The device of claim 14, wherein the service provider identifier is associated with one of a store, a bank, or a loyalty program.

16. The device of claim 13, wherein the payment information comprises a credit card track.

17. The device of claim 13, wherein the token generated by the token generator comprises a QR code.
